(19) United States
(12) Patent Application Publication
(10) Pub. No.: US 2006/0026531 A1
(43) Pub. Date: Feb. 2, 2006

(54) State-based computer help utility

(75) Inventors: Frank Li-De Lin, Escondido, CA (US); Francis Dione V. Callo, San Jose, CA (US)

Correspondence Address: ROGITZ & ASSOCIATES, 750 B STREET, SUITE 3120, SAN DIEGO, CA, 92101, US

(73) Assignees: SONY COPORATION; SONY ELECTRONICS INC.

(21) Appl. No.: 10/996,414

(22) Filed: Nov. 23, 2004

Related U.S. Application Data
(60) Provisional application No. 60/592,867, filed on Jul. 29, 2004.

(51) Int. Cl. G06F 3/00

(52) U.S. Cl. 715/809; 715/808

(57) ABSTRACT

A help utility application assists users to complete step-by-step processes in real time by providing information associated with each step in a sequence of data entry steps. The help utility application provides context-based functionality by determining a particular step in the sequence at which a user needs help. The help utility application also provides context-based functionality by branching based on data the user enters in one or more particular steps.

### RELATED APPLICATIONS

This application claims priority from U.S. provisional patent application Ser. No. 60/592,867, filed Jul. 29, 2004.

### I. FIELD OF THE INVENTION

The present invention relates generally to computer help utilities.

### II. BACKGROUND

Some computer help applications display text for a user to read in an effort to determine what data entries or settings are required as they complete a process on a computer. Other help applications display help information when, for example, the user moves a pointer (e.g., a mouse pointer) over a particular displayed control. As critically recognized herein, however, text files often confuse users, and pointer-based help features do not indicate to a user what step to perform next.

In lieu of using computer help features, a user may contact a customer service center to work with a person who can walk the user through a particular process and explain the various data entry choices that the user must make. Unfortunately, such customer service centers often can be difficult for users to contact (e.g., due to high call volume) and are expensive to operate. Having made the above critical observations, the invention herein is provided.

### SUMMARY OF THE INVENTION

A help application assists users to complete step-by-step processes in real time by providing information associated with each step in a sequence of data entry steps. The help application provides context-based functionality by determining a particular step in the sequence at which a user needs help. The help application also provides context-based functionality by branching based on user actions in one or more particular steps.

Accordingly, a help utility application is disclosed that is executed on a computing platform. The help utility application includes coded instructions for acts that include displaying a first instruction display box that is associated with a first user interaction scenario. The first instruction display box may, if desired, include text instructions associated with data that is to be entered via a first data entry field. The method acts also include automatically displaying a second instruction display box that is associated with a second user interaction scenario, with the second instruction display box including text instructions associated with data that is to be entered via a second data entry field. The automatic display of the second instruction display box is based on completion of data entry via the first data entry field.

In some embodiments the text instructions associated with data that is to be entered via the second data entry field are based on the data that has been entered via the first data entry field. The method acts of the help utility may further include displaying one or more pointers that visually associate the instruction display boxes and the data entry fields.

In another aspect, a computer help utility includes means for determining a state of a client set-up application, and means for determining in real time a next step related to the set-up application. Means are provided for presenting help information in entering data in the next step, responsive to the means for determining in real time.

In non-limiting implementations of the second aspect of the invention, the means for determining a state correlates a client process window being displayed to a user to help instructions. The help utility may use a script containing steps of a client application for which help may be required. Information associated with the help utility that is related to steps in the client application may include one or more of: text to display instructions or queries to display to the user, a window or control identifying a current step, a description to a function that can run a test to determine what the next step should be, and branching/forking information indicating, based on a state of the client application, where to jump to various other parts of the script. Also, tests can be run to determine various states and/or capabilities of computer hardware and/or software, e.g., a wireless card.

In further non-limiting implementations of the second aspect of the invention, the help utility automatically steps to a different part in the script using a hook inserted into a message queue of the client application. The hook searches for a subset of standard windows messages that occur when predetermined actions are performed. The predetermined actions can include window state information and user actions on controls.

Or, the help utility can automatically step to a different part in the script using a peeking mechanism that triggers at an interval to peek ahead to determine whether the user has advanced to a next step in the client process. The peeking mechanism may advance to a next step of the help utility by ascertaining buttons manipulated by a user, and/or by ascertaining old or current windows that have been closed, and/or by ascertaining new windows that have been opened.

In yet another aspect, a method for presenting computer help to a user includes providing a help utility running at least one script related to at least one client application. The method also includes, based on where a user is in the client application, determining a next step the user should take in the client application. Based on this, the method identifies a corresponding portion of the script for display of help information to the user.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system architecture;

FIG. 2 is a flow chart of the overall logic;

FIGS. 3 and 4 are diagrammatic views illustrating how an application window can be identified;

FIGS. 5-7 are a diagrammatic views showing a user interface display and associated help application functions in accordance with one embodiment of the invention; and

FIGS. 8 and 9 are diagrammatic views showing a user interface display and associated help application functions in accordance with another embodiment of the invention.

### DETAILED DESCRIPTION OF THE PREFERRED EMBODIMENT

The embodiments described herein are illustrative of various embodiments. Certain well-known functions and features have been omitted from this description so as to more clearly describe the invention. Coding may be performed in various ways well-known to those of skill in the art and is routine in view of this description.

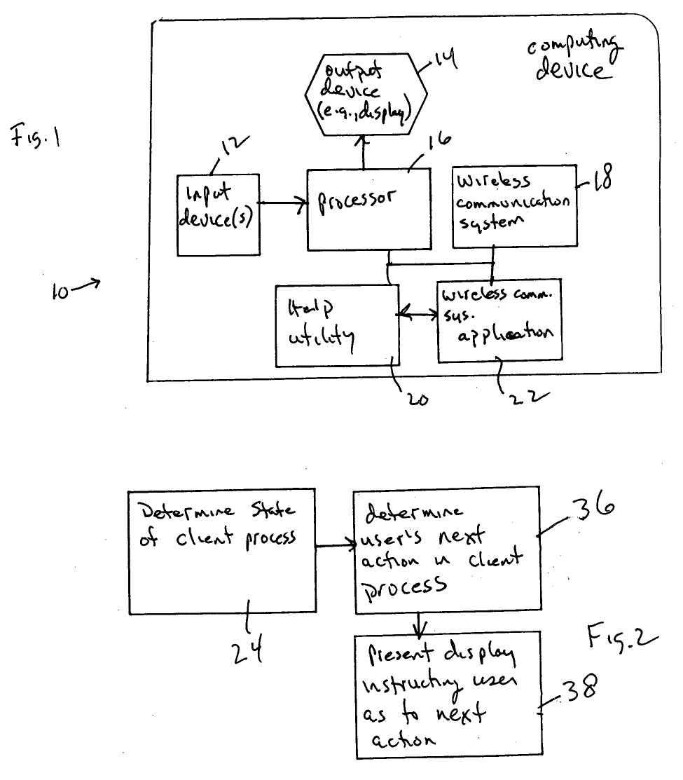

Referring initially to FIG. 1, a computing device 10 is shown that can use the present help utility. The computing device 10 may be any appropriate device such as a desktop or laptop computer (e.g., a VAIO computing system made by Sony Corporation), a gaming computer system, or a portable computing platform (e.g., a palmtop computer, personal digital assistant, cellular telephone handset, etc.) As shown, the computing device 10 may include one or more input devices 12, such as but not limited to keyboards, keypads, mice, joysticks, trackballs, and the like, and one or more output devices 14, such as but not limited to a monitor, printer, network, etc. Information can be entered into a processor 16 of the computing device 10 using the input device 12, and data from the processor 16, including the below-described displays, may be displayed on the output device 14. If desired, the processor 16 may communicate with other computers using a wireless communication system 18, such as but not limited to Bluetooth, wi-fi, other rf (e.g., CDMA, TDMA, GSM), or other communication system.

In accordance with the present invention, a software-implemented help utility application 20 can be accessed by the processor 16 to provide step-by-step assistance in real time to a person using the device 10. By way of non-limiting example, the help utility application 20 may be used to assist a person in setting up a client process such as a wireless communication system application 22 for controlling the wireless communication system 18.

FIG. 2 shows the overall logic of the present invention. Commencing at block 24, the help utility application 20 first determines the state of the client process 22 for which help instructions may be required. In one implementation the help utility application 20 determines this state by prompting the user to answer one or more queries and then examining the user's answers to the query(ies). In another implementation the help utility application 20 uses coded functions to determine the computing platform's state.

With greater particularity regarding the latter implementation, a library of functions can be included in the help utility 20 to test for certain states in the computing device 10 and return values that will tell the help utility 20 where to branch. For instance, if a particular error is detected, the help utility 20 will branch to the portion of the help utility 20 that instructs the user how to correct the problem. If the error is not present, the help utility skips the corresponding steps. In any case, these functions do not need to be compiled, but rather can be loaded and unloaded at run-time.

In ascertaining the state of the computing device 10, the help utility application 20 may identify the particular window being displayed by, e.g., the client process 22, and based on that determine the system state and, hence, what help information is relevant to present to the user for the current and next activity the user must perform. Many operating systems provide a mechanism called “FindWindow” that will find a window given its title or class, and when this is sufficient to uniquely identify the current window, the help utility correlates the window with the relevant help information. As recognized herein, however, the title and class of a particular window may be variable, or too general to uniquely identify a window. In this case, the help utility 20 uses additional characteristics of the window.

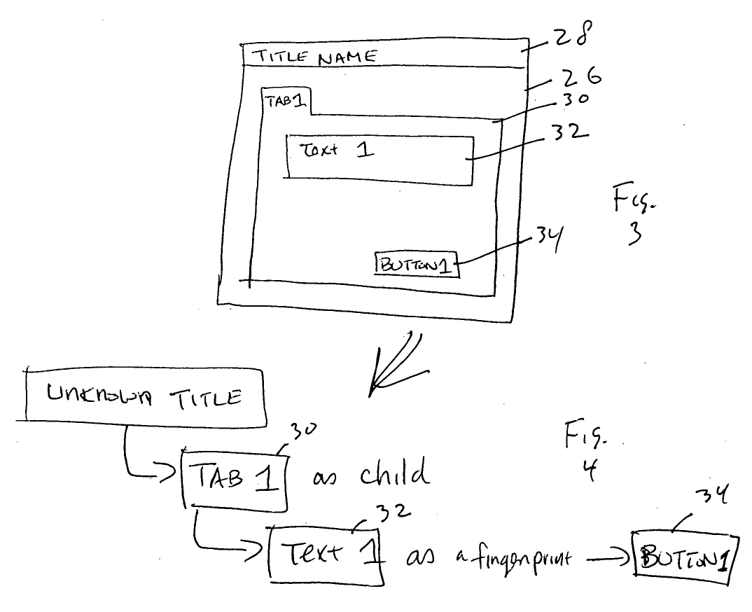

Referring briefly to FIGS. 3 and 4 for a greater understanding, an exemplary non-limiting window 26 is shown that may or may not have a title name 28. The additional characteristics can include a window tab 30 containing a text string 32 that is unique to the window 26. Thus, the additional characteristics can include a top-down sequence of text, control IDs and/or class-types. As an example, in one of the wireless setup windows when the client process is the communication system application 22, the name of the window can change, depending on when the user inserted his card, how many cards he has, etc, but the window has the text string, “Use Windows to configure my wireless network settings”. Because the chances of another window having this same string and the same top-down level are minor, this characteristic is correlated to the window 26 to identify the window 26. If desired, to increase the confidence level of uniquely identifying a window, multiple latches can be used in a single window, for instance, a button 34 that appears with the text string 32 may also be used to identify the window 26. Other window identification characteristics may include, instead of using an entire text string, a hash of the combination, levels, control IDs, etc. Or, the entire sequence may be broken down into a unique 32-bit (or 64 bit, 128 bit, etc.) value that can identify the combination and, hence, the window 26.

Returning to FIG. 2, once the help utility application 20 has determined the state of the particular process, at block 36 the help utility application 20 automatically determines what the user's next action should be. At each step in the particular process the user is performing, therefore, the help utility application 20 can branch to a different portion of the process that is appropriate to the situation.

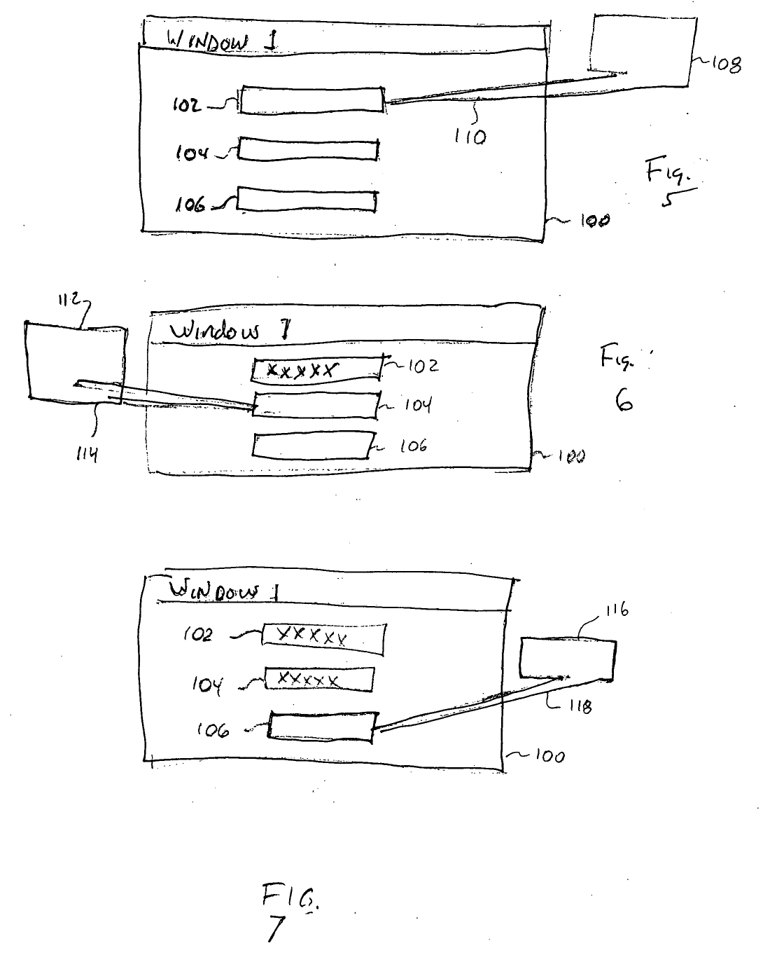

With more specificity, a script (in, e.g., XML) can be used by the help utility application 20 that contains the steps of the process of the client application 22 for which help may be required. Help information (referred to as a stepinfo object) in the help utility 20 that is related to each step in the client application 22 may contain combinations of the following information. A stepinfo object may include text to display instructions or queries to display to the user, as well as a window or control on the computer to identify the current step, illustrated in FIGS. 5-7 and discussed more fully below. A stepinfo object may also include a description to a function that can run a test to determine what the next step should be and when to display this, as well as modifiers to fully integrate the program into the different types of windows being monitored. Still further, a stepinfo object may include branching/forking information that indicates, based on the state of the system, where to jump to various other parts of this script.

Thus, it may be determined that the help utility should automatically step to the next process and/or when the setup process should be changed. Instead of having the user continually move back and forth between the dynamic setup window of the help utility discussed further below and the corresponding client application 22 windows, it may be determined when the user has moved on to the next step, or has otherwise changed the environment. This may be accomplished with two mechanisms. A hook may be inserted into the message queue of the current client application 22 window on which the help utility 20 is rendering information, and this hook looks for a subset of the standard windows messages that occur when common actions are performed. These might include window state information (minimized, maximized, closed, activated) as well as user actions on certain controls (e.g., a button is clicked) A second mechanism that can be used is a peeking mechanism that triggers at intervals to “peek” ahead to determine whether the user has advanced to the next step in the client process 22. This peeking mechanism can advance to the next step of the help utility by looking for user interaction elements that have been activated, old or current windows that have been closed, and new windows that have been opened.

Once it has been determined what the user's next action should be, and what the current state of the system is, help information as set forth further below is displayed at block 38.

Now referring to FIGS. 5-7, a window 100 is displayed on, for example, the monitor 14 shown in FIG. 1. The window 100 is associated with the client process 22, e.g., an application for configuring wireless network settings within a WINDOWS operating system. In the non-limiting embodiment shown for illustration, the window 100 may include three fields 102, 104, and 106 that each require data entered by the user. These fields, and ones similar that are described below, may receive data in various ways such as direct entry and drop down menus. Such fields are also illustrative of other ways of entering data, such as selecting check boxes or radio buttons.

As shown in FIG. 5, if the application that generates the window 100 is ready to receive data in the first field 102, the help utility application 20 generates an instruction display box 108 that contains text instructions. The text instructions in the instruction display box 108 tell the user what to enter in first field 102. To further assist the user, a pointer 110 can extend from the instruction display box 108 to the first field 102 to emphasize that the text instructions in the instruction display box 108 are associated with the first field 102. In some instances, two or more instruction display boxes 108 may be displayed to, for example, explain several possible choices presented in a drop-down menu.

Once the user enters data in the first field 102, the help utility application 20 may examine the entered data to determine if it is correct. If so, the help utility application 20 steps to data associated with a second field 104. If the data entered in the first field 102 is incorrect, the help utility application 20 may, for example, repeat the display of the instruction display box 108, using either the originally displayed text instructions or revised instructions that further prompt the user to enter the correct data. In some embodiments the help utility application 20 does not examine data entered in the first field 102 (or in the second and third fields 104, 106 as described below).

After the user enters data in the first field 102, represented by a series of X's in FIG. 6, the second field 104 is ready to accept data. As shown in FIG. 6, the help utility application 20 removes the instruction text box 108 and its associated pointer 110 from the display, and then it displays an instruction display box 112 that contains another set of text instructions. The text instructions (not shown) in the instruction display box 112 tell the user what to enter in the second field 104. To further assist the user, a pointer 114 can run from the instruction display box 112 to the second field 104 to emphasize that the text instructions in the instruction display box 112 are associated with the second field 104.

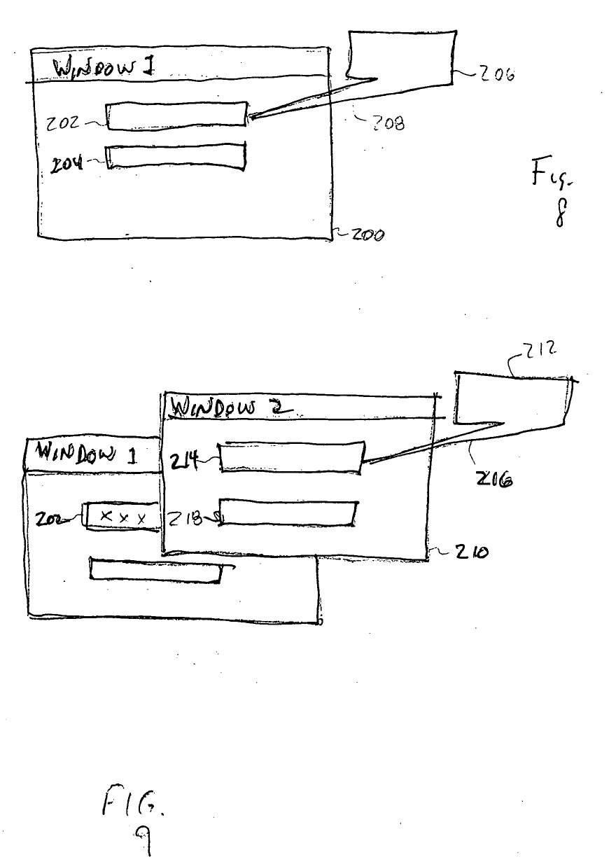

After the user enters data in the second field 104, illustrated by a series of X's as shown in FIG. 7, a third field 106 is ready to accept data. As shown in FIG. 7, the help utility application 20 removes the instruction text box 112 shown in FIG. 6 and its associated pointer 114 from the display, and then it displays yet another instruction display box 116 that contains yet another set of text instructions. The text instructions (not shown) in the instruction display box 116 tell the user what to enter in the third field 106. To further assist the user, a pointer 118 may extend from the instruction display box 116 to the third field 106 to emphasize that the text instructions in the instruction display box 116 are associated with the third field 106.

The displays shown in FIGS. 5-7 are illustrative of various displays that can be used with the step-by-step help functionality in accordance with the invention. This functionality can be used with two or more windows.

More specifically, now referring to FIGS. 8 and 9, a window 200 may be displayed in a manner similar to that described for the window 100 shown in FIGS. 5-7. As described above, the help utility application 20 displays an instruction display box 206 and associated pointer 208 to assist the user entering data in a first field 202. Unlike the embodiment exemplified by FIGS. 5-7, however, as shown in FIG. 9 the client process 22 being completed by the user may require data to be entered via fields contained in a second window 210. Accordingly, the process being completed by the user displays a second window 210 either to replace or in addition to the window 200. This second window 210 may be displayed because of the specific data entered in the first field 202 (shown as a series of X's). The fields displayed in the second window 210 might be different if, for instance, alternate data had been entered in the first field 202. As a result of the window 210 display, the help utility application 20 displays an instruction display box 212 that contains text instructions (not shown) that assist the user to enter data in the field 214 of the window 210, and if desired a pointer 216 may extend from the instruction display box 212 to the field 214 to further assist the user to enter data in the field 214. If the window 210 fields were different, the text in the instruction display box 212 would be associated with the alternate fields.

In this way the help utility application 20 provides a contextual, if-then feature that helps the user enter required data. That is, one data entry in the field 202 triggers one embodiment of the window 210 and its field 214, which in turn prompts the help utility application 20 to display one instruction set in the display instruction box 212. Alternatively, a second data entry in the field 202 triggers a second embodiment of the window 210 and its field 214, which in turn prompts the help utility application 20 to display a second instruction set in the display instruction box 212.

The help utility application 20 continues in a manner similar to that described above to assist the user with data required in other fields of the window 210. After assisting the user with the window 210, the help utility application 20 can continue to assist the user with further entries required by the process the user is completing, e.g., returning to the window 200, opening yet another window that requires data entry, or ending the process.

In accordance with the invention, therefore, the user receives step-by-step, real time help as he or she completes a process such as setting up an application in a computer. In addition, the help is contextual because the help utility application 20 determines what actions, if any, have been completed and begins the help functionality with the next required step. Further, the help branches based on if-then conditions such as the user's previous data field entry. This functionality of the help utility application 20 is in contrast to systems that provide help files for users to read (often displayed in a separate window if the user selects a “help” control) or that display a pop-up help window if the user moves a mouse over a particular control.

While the particular STATE-BASED COMPUTER HELP UTILITY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A help utility application that is executed on a computing platform, the help utility application being coded instructions for acts comprising:
displaying a first instruction display box that is associated with a first user interaction, the first instruction display box comprising text instructions associated with data that is to be entered; and
automatically displaying a second instruction display box that is associated with a second user interaction, the second instruction display box comprising text instructions associated with data that is to be entered via a second data entry field; wherein
the automatic display of the second instruction display box is based on completion of data entry via the first data entry field.

2. The help utility application of claim 1, wherein the text instructions associated with data that is to be entered via the second data entry field are based on the data that has been entered via the first data entry field.

3. The help utility application of claim 1, the acts further comprising:
displaying a first pointer that visually associates the first instruction display box and the first data entry field; and
displaying a second pointer that visually associates the second instruction display box and the second data entry field.

4. The help utility application of claim 1, wherein the first data entry field is displayed in a first window and the second data entry field is displayed in a second window.

5. A help utility, comprising:
means for determining a state of a client set-up application;
means for determining in real time a next step related to the set-up application; and
means for presenting help information in entering data in the next step, responsive to the means for determining in real time.

6. The help utility of claim 5, wherein the means for determining a state correlates a client process window being displayed to a user to help instructions.

7. The help utility of claim 5, wherein the help utility uses a script containing steps of a client application for which help may be required.

8. The help utility of claim 7, wherein information associated with the help utility that is related to steps in the client application includes two or more of: text to display instructions or queries to display to the user, a window or control identifying a current step, a description to a function that can run a test to determine what the next step should be, and branching/forking information indicating, based on a state of the client application, where to jump to various other parts of the script.

9. The help utility of claim 8, wherein the help utility automatically steps to a different part in the script using a hook inserted into a message queue of the client application, the hook searching for a subset of standard messages that occur when predetermined actions are performed.

10. The help utility of claim 9, wherein the predetermined actions include at least one of: window state information, user actions on user interface controls, and user responses to queries.

11. The help utility of claim 8, wherein the help utility automatically steps to a different part in the script using a peeking mechanism that triggers at intervals to peek ahead to determine whether the user has advanced to a next step in the client process.

12. The help utility of claim 11, wherein the peeking mechanism advances to a next step of the help utility by ascertaining user interfaces manipulated by a user.

13. The help utility of claim 11, wherein the peeking mechanism advances to a next step of the help utility by ascertaining old or current windows that have been closed.

14. The help utility of claim 11, wherein the peeking mechanism advances to a next step of the help utility by ascertaining new windows that have been opened.

15. A method for presenting computer help to a user, comprising:
providing a help utility running at least one script related to at least one client application;
based on where a user is in the client application, determining a next step the user should take in the client application; and
based thereon, identifying a corresponding portion of the script for display of help information to the user.

16. The method of claim 15, wherein information associated with the help utility that is related to steps in the client application includes two or more of: text to display instructions or queries to display to the user, a window or control identifying a current step, a description to a function that can run a test to determine what the next step should be, branching/forking information indicating, based on a state of the client application, where to jump to various other parts of the script, and determinination of device states.

17. The method of claim 16, wherein the help utility automatically steps to a different part in the script using a hook inserted into a message queue of the client application, the hook searching for a subset of standard messages that occur when predetermined actions are performed.

18. The method of claim 17, wherein the predetermined actions include at least one of: window state information, and user actions on user interaction controls.

19. The method of claim 16, wherein the help utility automatically steps to a different part in the script using a peeking mechanism that triggers at an interval to peek ahead to determine whether the user has advanced to a next step in the client process.

20. The method of claim 19, wherein the peeking mechanism advances to a next step of the help utility by at least one of: ascertaining buttons manipulated by a user, ascertaining old or current windows that have been closed, and ascertaining new windows that have been opened.
